(19) United States
(12) Patent Application Publication
(10) Pub. No.: US 2002/0179344 A1
(43) Pub. Date: Dec. 5, 2002

(54) Suspension system arrangement and method

(76) Inventors: Martin K. Boulton, Iluka (AU); Lorenzo Mattaboni, Balcatta (AU); Mark J. Pivac, Lesmurdie (AU); Maxwell A. Weston, Canning Vale (AU)

Correspondence Address: CATERPILLAR INC., 100 N.E. ADAMS STREET, PATENT DEPT., PEORIA, IL, 616296490

(21) Appl. No.: 09/871,126

(22) Filed: May 31, 2001

(51) Int. Cl. B62D 61/10

(52) U.S. Cl. 180/22

(57) ABSTRACT

In the operation of work machines of the type requiring traversal over rough terrain, it is oftentimes beneficial to provide a work machine with parts requiring little or no maintenance. The present invention provides a work machine having a chassis and at least one mounting member attached to the chassis. At least one elongate member has a first end which is rotatably coupled to the mounting member. A self-lubricating member is situated between the first end and the mounting member.

### TECHNICAL FIELD

This invention relates to a suspension system arrangement and, more specifically, to a suspension system mounting arrangement thereof which utilizes maintenance free members between moving parts.

### BACKGROUND

Work machines of the type used to remove downed timber from timber harvest areas oftentimes must navigate across rough terrain consisting of uneven ground slopes and obstacles such as stumps, downed timber and rocks. To navigate over such terrain, it has been found beneficial to employ the use of pendulum arm-type suspensions which allow for greater movement of the work machine's tires relative to the work machine's chassis. To provide relative movement between the chassis of the work machine and each pendulum arm, slew bearings, needle bearings or other roller-bearing type devices are typically used to mount the pendulum arms to the chassis all of which oftentimes requires periodic maintenance.

The prior are is replete with examples of mounting pendulum arm-type suspension systems to the chassis of a vehicle. Example of such mounting arrangement can be found in U.S. Pat. No. 5,263,736 which issued on Nov. 23, 1993 to Stevens; U.S. Pat. No. 4,600,069 which issued on Jul. 15, 1986 to Oswald et al.; U.S. Pat. No. 4,230,341 which issued Oct. 28, 1980 to Hart et al.; U.S. Pat. No. 3,601,424 which issued on Aug. 24, 1971 to Badland; and U.S. Pat. No. 2,988,374 which issued on Jun. 13, 1961 to Boyles. Although each of these arrangements may be adequate for their respective intended purposes, neither teaches to use of a self-lubricating bearings for use in mounting the pendulum arms to the chassis.

The subject invention is directed at overcoming one or more of the problems as set forth above.

### SUMMARY OF THE INVENTION

In one aspect of the present invention, a work machine is provided. The work machine includes a chassis, and at least one mounting member attached to the chassis. Also provided is at least one elongate member having a first end rotatably coupled to the mounting member. A self-lubricating member is situated between the first end and the mounting member.

In another aspect of the present invention a method of providing a self-lubricating suspension system for a work machine having a chassis is provided. The method includes the steps of coupling at least one mounting member to the chassis, providing at least one elongate member having a first end and a second end, attaching a self-lubricating member to a surface of an opening provided in the first end, and attaching the first end to the mounting member in such manner that the self-lubricating member is between the first surface and the mounting member.

### BRIEF DESCRIPTION OF THE DRAWINGS

FIG. 1 is a side elevation view of a work machine of the present invention embodying the principles of the present invention;

FIG. 2 is a diagrammatical side elevation view of an elongated member for use with the work machine of FIG. 1;

FIG. 3 is a diagrammatical cross-sectional view taken through lines 3-3 of FIG. 3; and

FIG. 4 is a diagrammatical perspective view of a self-lubricating member for use with the present invention.

### DETAILED DESCRIPTION

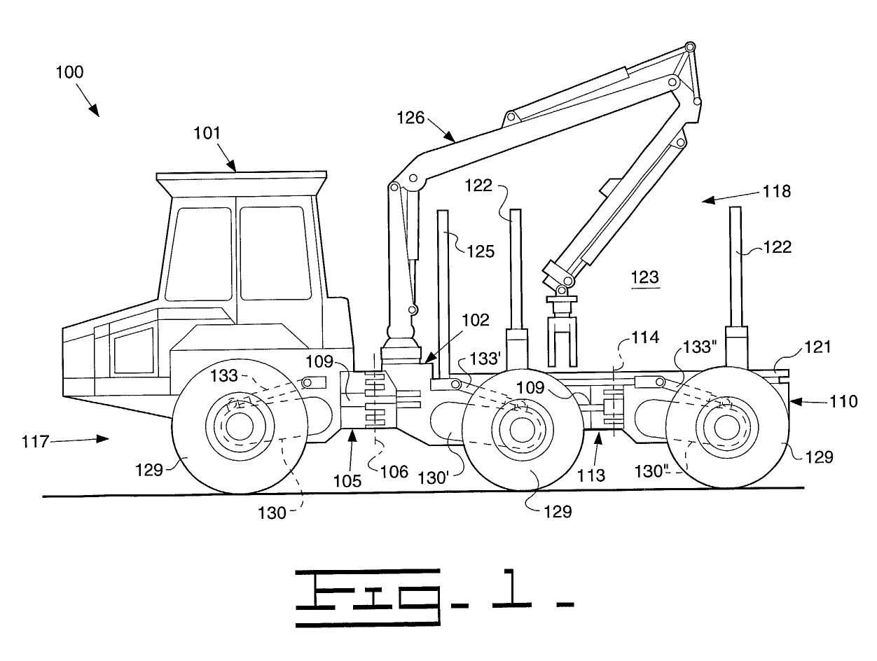

With reference now to the Figures, shown in FIG. 1 is a work machine 100 embodying the principles of the present invention. The work machine 100 includes a cab portion 101 and a first trailer portion 102 hingedly coupled to the cab portion 101 at articulation joint 105. As should be apparent, the articulation joint 105 allows the cab portion 101 and first trailer portion 102 to be articulable relative to each other about a vertical axis 106 with articulation preferably being provided in a conventional manner such as by the use of hydraulic cylinders 109. A second trailer portion 110 is preferably hingedly coupled to the first trailer portion 102 at articulation joint 113, thereby allowing for relative articulation of the first and second trailer portions 102,110 about a vertical axis 114. As should be appreciated by those skilled in such art, such an arrangement allows for tighter turning radii than otherwise would be possible for a single trailer having the same effective length as the combined first and second trailers portions 102,110.

The cab portion 101 along with the first and second trailer portions 102,110 collectively define a chassis of the work machine 100 which is shown generally at 117. A bunk assembly 118 is pivotally attached to the chassis 117 and is defined by central beam 121 and a plurality of posts 122 attached thereto on each side of the chassis 117 and extending upwardly therefrom. The bunk assembly 118 therefore defines an open bunk area 123 for retaining a load, for example logs, therein. A conventional gate 125 may also be attached to the central beam 121. A work implement, preferably comprising a crane 126, is pivotally attached to the chassis 117 and is used for placing the logs within the bunk area 123.

A plurality of ground engaging members, preferably comprising six tires 129 (three shown), are coupled with the chassis 117 by use of corresponding elongated members or arms 130, 130′, 130″ (three shown).

Although the details of coupling each of the arms 130,130′,130″ to the chassis 117 will be described in greater detail as this disclosure progresses, suffice to say for now each arm 130,130′,130″ is rotatably coupled to the chassis 117 and each is controlled by a respective hydraulic cylinder 133,133′,133″. It is to be understood that although only three arms 130,130′,130″ and respective hydraulic cylinders 133,133′,133″ are shown, the work machine 100 described herein also includes three corresponding hydraulic cylinder/arm arrangements on the other side of the work machine 100.

In FIG. 2 is shown arm 130 with the tire 129 removed. For purposes of brevity, the following discussion will make reference to arm 130 only but it is to be understood that the teachings herein apply equally to the remaining arms 130′ and 130″. Arm 130 includes a first end 201 which is pivotally coupled to the chassis 117, and a second end 202 which forms a housing for receiving a motive device 203 for imparting motion to a respective tire 129. For the work machine 100 described herein, it is preferred that the motive device 203 comprise a hydraulic motor, however other motive devices 203 may be employed without deviating from the present invention such as, for example, an electric motor, a chain drive system, or other like arrangements. As is further shown, the second end 202 includes a flange 206 for coupling the arm 130 to the hydraulic cylinder 133. The arm 130 further includes a planar portion 209 extending between the first and second ends 201,202.

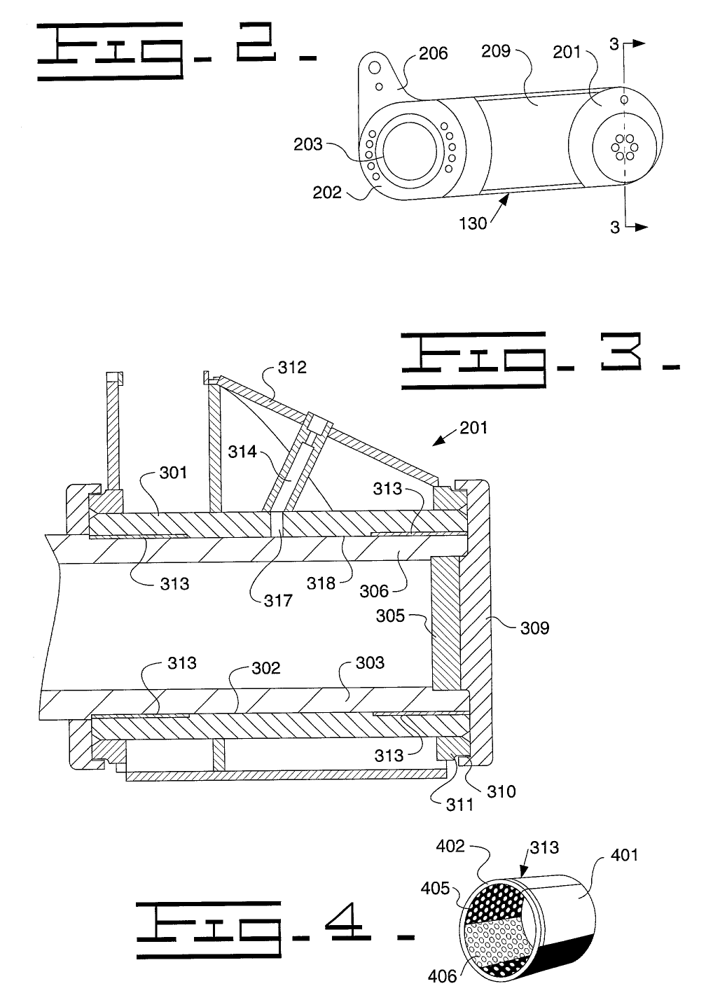

Shown in cross-section in FIG. 3 are the details of the first end 201 of arm 130 as attached to the chassis 117. The first end 201 includes a sleeve portion 301, having a surface 302, sized to receive a mounting member, preferably comprising an axle 303, which is coupled to the chassis 117. As shown, the axle 303 is preferably substantially hollow and may include a shim 305 attached adjacent to the axle end 306. Substantially abutting the shim 305 is a retainer cap 309 which is attached to the sleeve portion 301. A seal 310, preferably comprising a Teflon seal, may be placed between the retainer cap 309 and sleeve end portion 311. A plate 312 extends substantially between the retainer cap 309 and the planar portion 209. As shown, the plate 312 preferably is oriented at an angle relative to the sleeve portion 301 so as to provide the first end 201 with a substantially truncated cone geometry.

Situated between the axle 303 and the sleeve portion 301 are preferably a pair of self-lubricating members 313 which are used to facilitate relative movement between the axle 303 and sleeve portion 301. As should be appreciated, and as the name implies, the self-lubricating members 313 are preferably dry sliding bearings of the type commercially available under the trademark GLYCODUR® and which do not require outside lubrication to maintain their bearing-like qualities. As should also be appreciated by those of ordinary skill in such art, the self-lubricating members 313 of the type described herein are relatively thin, typically up to and including 2 mm, which allows for smaller sized axles 303 and arms 130,130′,130″, thereby reducing the overall weight of the work machine 100. The user may, at the users option, supply an outside source of lubrication to each of the self-lubricating members 313. To facilitate any such external lubrication, the first end 201 is provided with a passageway 314 which substantially overlaps a corresponding opening 317 provided in the sleeve portion 301. The provided lubrication fills the opening 318 interleaved between the sleeve portion 301 and the axle 303 and migrates to each self-lubricating member 313.

Shown in FIG. 4 is an exemplary self-lubricating member 313 of the type described herein. As shown, each self-lubricating member 313 is substantially cylindrical in shape and comprises a copper-clad sheet steel backing 401 with a 0.2 mm to 0.35 mm thick sintered layer 402 of tine bronze attached to the backing 401. A surface layer 405, comprised substantially of acetal resin (polyoxymethylene), is firmly anchored in the sintered layer of tin bronze. The surface layer 405 may include a plurality of lubrication retaining pockets 406 which help to capture and retain any external lubrication that may be used.

### INDUSTRIAL APPLICABILITY

With reference to the drawings and in operation, the self-lubricating member 313 allows for relative movement between each respective arm 130,130′,130″ and its respective axle 303 without the need for periodic maintenance of the self-lubricating member 313. Also, as should be appreciated, the provision of such a self-lubricating member 313 having a thickness of 2 mm or less allows for the first ends 201 of the arms 130,130′,130″ and axles 303 to have a smaller diameter relative to what otherwise would be the case if conventional bearings were used. This, in turn, allows for a reduced weight of the work machine 100 resulting in less damage to the ground surface along with an increased clearance.

Other aspects, objects and advantages of this invention can be obtained from a study of the drawings, the disclosure and the appended claims.

What is claimed is:

1. A work machine, comprising:
a chassis;
at least one ground engaging member;
at least one mounting member attached to said chassis;
at least one elongate member having a first end and a second end;
said first end rotatably coupled to said mounting member;
said second end coupled to said ground engaging member; and
a self-lubricating member situated between said first end and said mounting member.

2. The work machine as set forth in claim 1 wherein said chassis includes:
a cab portion; and
a first trailer portion hingedly coupled to said cab portion.

3. The work machine as set forth in claim 1 including a motive device coupled to said second end for imparting motion to said ground engaging member.

4. The work machine as set forth in claim 3 wherein said motive device is a hydraulic motor.

5. The work machine as set forth in claim 1 including a second trailer portion coupled to said first trailer portion.

6. The work machine as set forth in claim 5 wherein said second trailer portion is articulable relative to said first trailer portion.

7. The work machine as set forth in claim 1 wherein said self-lubricating member has a thickness of up to 2 mm.

8. The work machine as set forth in claim 1 wherein:
said self-lubricating member includes a surface layer; and
said surface layer includes at least one lubrication retaining pocket.

9. The work machine as set forth in claim 8 wherein said surface layer comprises a substantially polyoxymethylene material.

10. A method of providing a self-lubricating suspension system for a work machine of the type having a chassis and at least one ground engaging member, comprising the steps of:
coupling at least one mounting member to said chassis;
providing at least one elongate member having a first end, having a sleeve portion, and a second end;
attaching a self-lubricating member to a surface of said sleeve portion; and
attaching said first end to said mounting member in such manner that said self-lubricating member is between said surface and said mounting member.

11. The method as set forth in claim 10 including the step of providing at least one lubrication retaining pocket in a surface layer of said self-lubricating member.

12. The method as set forth in claim 10 wherein said mounting member is an axle.

13. The method as set forth in claim 10 wherein said self-lubricating member has a thickness of up to 2 mm.

14. A work machine comprising:
a chassis having (i) a cab portion, and (ii) a first trailer portion hingedly coupled to said cab portion;
at least four ground engaging members;
at least four mounting members attached to said chassis;
at least four elongate members each having a first end and a second end;
each said first end of one of said elongate members rotatably coupled to one of said mounting members;
each said second end coupled to one of said ground engaging members;
a self-lubricating member situated between each said first end and each said mounting member;
a motive device coupled to each said second end for imparting motion to said attached ground engaging member; and
a second trailer portion hingedly coupled to said first trailer portion.

15. The work machine as set forth in claim 14 including:
six ground engaging members;
six mounting members; and
six elongate members.

16. The work machine as set forth in claim 14 including:
eight ground engaging members;
eight mounting members; and
eight elongate members.
